(19) United States
(12) Patent Application Publication
(10) Pub. No.: US 2020/0333492 A1
(43) Pub. Date: Oct. 22, 2020

(54) Marine Survey Route

(71) Applicant: PGS Geophysical AS, Oslo (NO)

(72) Inventor: Arne Vatn, Oslo (NO)

(73) Assignee: PGS Geophysical AS, Oslo (NO)

(21) Appl. No.: 16/851,571

(22) Filed: Apr. 17, 2020

Related U.S. Application Data
(60) Provisional application No. 62/959,383, filed on Jan. 10, 2020.
(60) Provisional application No. 62/835,078, filed on Apr. 17, 2019.

(51) Int. Cl. G01V 1/38

(52) U.S. Cl. CPC G01V 1/3808

(57) ABSTRACT

Geophysical data can be acquired while sailing in a first direction along adjacent lines of a first continuous subarea of a survey area, sailing in a second direction along adjacent lines of a second continuous subarea of the survey area, sailing in the first direction along alternating lines of a third continuous subarea between the first continuous subarea and the second continuous subarea, and sailing in the second direction along each of a second plurality of alternating lines of the third continuous subarea.

### CROSS-REFERENCE TO RELATED APPLICATIONS

This application claims priority to U.S. Provisional Application 62/835,078, filed Apr. 17, 2019 and U.S. Provisional Application 62/959,383, filed Jan. 10, 2020, which are incorporated by reference as if entirely set forth herein.

### BACKGROUND

In the past few decades, the petroleum industry has invested heavily in the development of marine survey techniques that yield knowledge of subterranean formations beneath a body of water in order to find and extract valuable mineral resources, such as oil. High-resolution images of a subterranean formation are helpful for quantitative interpretation and improved reservoir monitoring. For a typical marine survey, a marine survey vessel tows one or more marine survey sources (hereinafter referred to as “sources”) below the sea surface and over a subterranean formation to be surveyed. Marine survey receivers (hereinafter referred to as “receivers”) may be located on or near the seafloor, on one or more streamers towed by the marine survey vessel, or on one or more streamers towed by another vessel. The marine survey vessel typically contains marine survey equipment, such as navigation control, source control, receiver control, and recording equipment. The source control may cause the one or more sources, which can be impulsive sources such as air guns, non-impulsive sources such as marine vibrator sources, electromagnetic sources, etc., to produce signals at selected times. Each signal is essentially a wave called a wavefield that travels down through the water and into the subterranean formation. At each interface between different types of rock, a portion of the wavefield may be refracted, and another portion may be reflected, which may include some scattering, back toward the body of water to propagate toward the sea surface. The receivers thereby measure a wavefield that was initiated by the actuation of the source.

### BRIEF DESCRIPTION OF THE DRAWINGS

FIG. 1 is an elevation or xz-plane view of marine surveying in which signals are emitted by a source for recording by receivers.

FIG. 2 is a plan or xy-plane view of a marine survey route according to some previous approaches.

FIG. 3A is a plan or xy-plane view of an exemplary embodiment of a first portion of a marine survey route.

FIG. 3B is a plan or xy-plane view of an exemplary embodiment of a first and a second portion of a marine survey route.

FIG. 4A is a plan or xy-plane view of an exemplary embodiment of a first portion of marine survey route.

FIG. 4B is a plan or xy-plane view of an exemplary embodiment of a first portion and a third portion of a marine survey route.

FIG. 4C is a plan or xy-plane view of an exemplary embodiment of a first portion, a third portion, and a second portion of a marine survey route.

FIG. 5 illustrates an exemplary embodiment of a machine-readable medium for a marine survey route.

FIG. 6 illustrates an exemplary embodiment of a system for a marine survey route.

### DETAILED DESCRIPTION

The present disclosure is related to a marine survey route for marine geophysical surveying using towed streamers. At least one embodiment of the present disclosure can include a marine survey route comprising a continuous swath for an entire survey area. A swath includes parallel lines sailed by the marine survey vessel and the turns executed from one line to another. The term “sail” does not imply the use of sails for propulsion but means move or travel on water by a vessel. In some previous approaches, a marine survey area may be divided such that a marine survey vessel uses more than one swath to survey the survey area. The time and distance used by the marine survey vessel sailing from one swath to another are inefficient and expensive. At least one embodiment of the present disclosure can reduce such inefficiencies by not requiring a turn with a large radius between swaths. For example, some previous approaches may include turning with a nearly constant radius between different lines of a swath until the swath is complete and then making a large radius turn to get to a next swath. In some cases, the turn from a last line of a first swath to a first line of a second swath may cover half of an area surveyed by one swath, or more.

As used herein, the singular forms “a”, “an”, and “the” include singular and plural referents unless the content clearly dictates otherwise. Furthermore, the word “may” is used throughout this application in a permissive sense (i.e., having the potential to, being able to), not in a mandatory sense (i.e., must). The term “include,” and derivations thereof, mean “including, but not limited to.” The term “coupled” means directly or indirectly connected and, unless stated otherwise, can include a wireless connection.

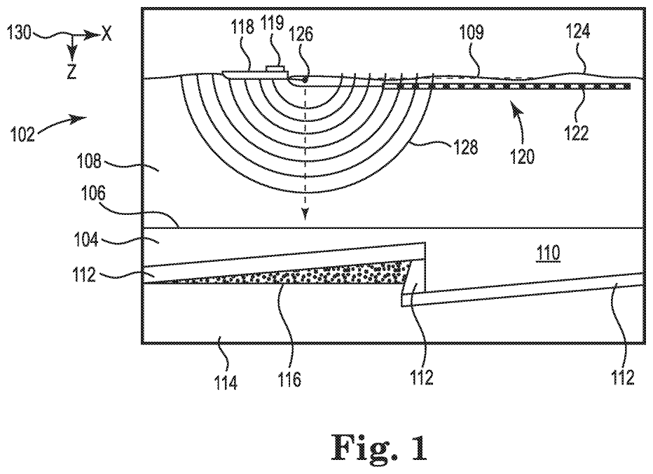

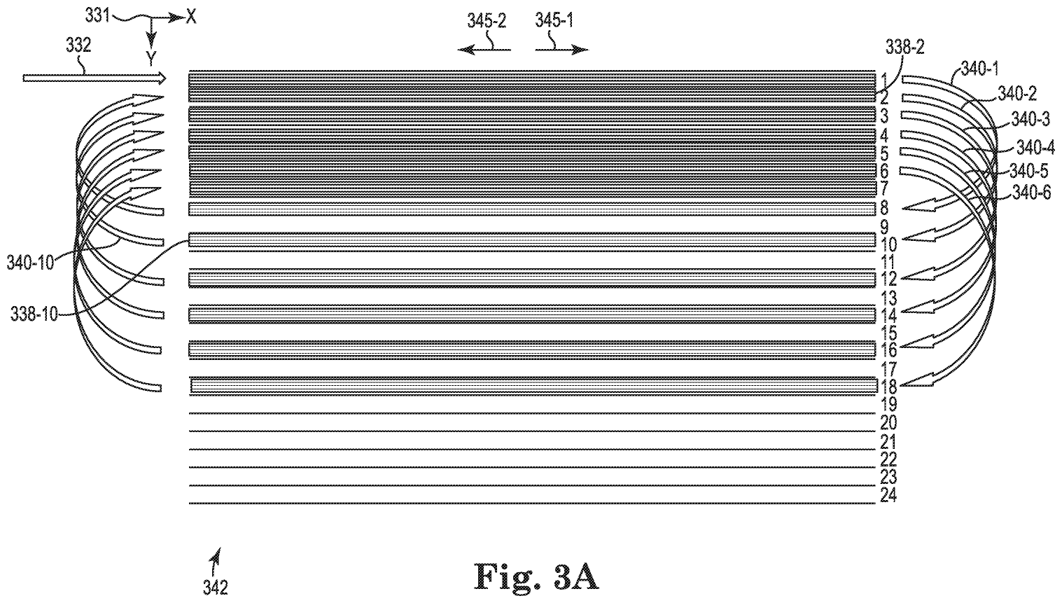

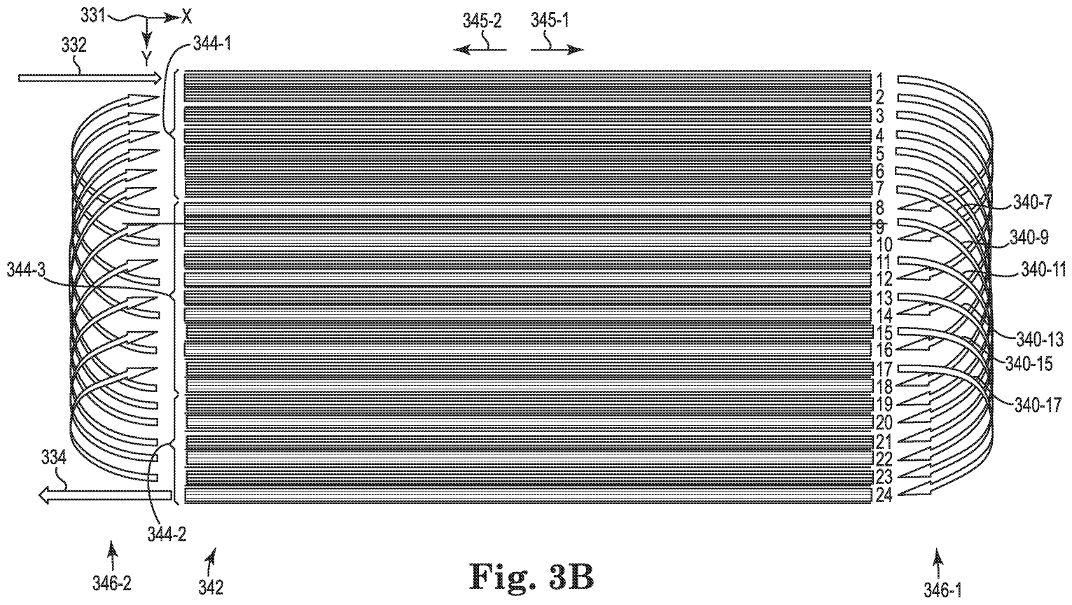

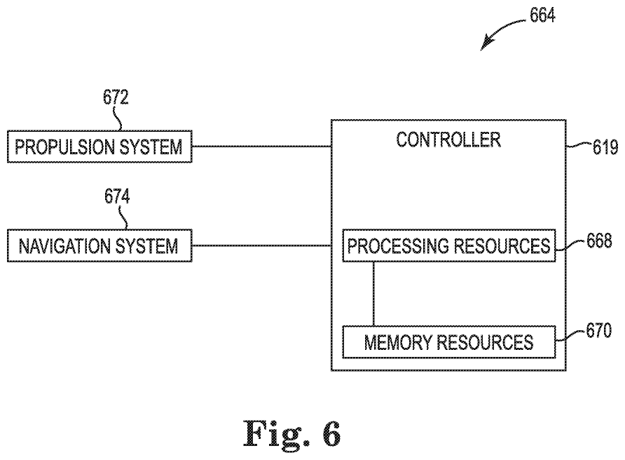

The figures herein follow a numbering convention in which the first digit or digits correspond to the drawing figure number and the remaining digits identify an element or component in the drawing. Similar elements or components between different figures may be identified by the use of similar digits. For example, 119 may reference element “19” in FIG. 1, and a similar element may be referenced as 619 in FIG. 6. Analogous elements within a Figure may be referenced with a hyphen and extra numeral or letter. See, for example, elements 340-1, and 340-2 in FIG. 3. As will be appreciated, elements shown in the various embodiments herein can be added, exchanged, and/or eliminated so as to provide a number of additional embodiments of the present disclosure. In addition, as will be appreciated, the proportion and the relative scale of the elements provided in the figures are intended to illustrate certain embodiments of the present invention and should not be taken in a limiting sense.

FIG. 1 is an elevation or xz-plane 130 view of marine surveying in which signals are emitted by a source 126 for recording by receivers 122. The recording can be used for processing and analysis in order to help characterize the structures and distributions of features and materials underlying the surface of the earth. For example, the recording can be used to estimate a physical property of a subsurface location, such as the presence of a reservoir that may contain hydrocarbons. FIG. 1 shows a domain volume 102 of the earth's surface comprising a subsurface volume 104 of sediment and rock below the surface 106 of the earth that, in turn, underlies a fluid volume 108 of water having a sea surface 109 such as in an ocean, an inlet or bay, or a large freshwater lake. The domain volume 102 shown in FIG. 1 represents an example experimental domain for a class of marine surveys. FIG. 1 illustrates a first sediment layer 110, an uplifted rock layer 112, an underlying rock layer 114, and a hydrocarbon-saturated layer 116. One or more elements of the subsurface volume 104, such as the first sediment layer 110 and the uplifted rock layer 112, can be an overburden for the hydrocarbon-saturated layer 116. In some instances, the overburden may include salt.

FIG. 1 shows an example of a marine survey vessel 118 equipped to carry out marine surveys in accordance with the present disclosure. In particular, the marine survey vessel 118 can tow one or more streamers 120 (shown as one streamer for ease of illustration) generally located below the sea surface 109. The streamers 120 can be long cables containing power and data-transmission lines (e.g., electrical, optical fiber, etc.) to which receivers may be coupled. In one type of marine survey, each receiver, such as the receiver 122 represented by the shaded disk in FIG. 1, comprises a pair of sensors including a geophone that detects particle displacement within the water by detecting particle motion variation, such as velocities or accelerations, and/or a receiver that detects variations in pressure. However, embodiments are not so limited. Surveys can include receivers 122 that are only pressure sensors, pressure and motion sensors, or electromagnetic sensors, among others. In one type of marine survey, each receiver, such as the receiver 122, comprises an electromagnetic receiver that detects electromagnetic energy within the water. The streamers 120 and the marine survey vessel 118 can include sensing electronics and data-processing facilities that allow receiver readings to be correlated with absolute locations on the sea surface and absolute three-dimensional locations with respect to a three-dimensional coordinate system. In FIG. 1, the receivers along the streamers 120 are shown to lie below the sea surface 109, with the receiver locations correlated with overlying surface locations, such as a surface location 124 correlated with the location of receiver 122.

The marine survey vessel 118 can tow a source 126 that produces signals as the marine survey vessel 118 and streamers 120 move across the sea surface 109. The source 126 and/or streamers 120 may also be towed by other vessels or may be otherwise disposed in fluid volume 108. For example, the receivers may be located on ocean bottom cables or nodes fixed at or near the surface 106. For the sake of efficiency, illustrations and descriptions herein show receivers located on streamers, but it should be understood that references to receivers located on a “streamer” or “cable” should be read to refer equally to receivers located on a towed streamer, an ocean bottom receiver cable, and/or an array of nodes. The marine survey vessel 118 can include a controller 119. For example, the controller 119 can be coupled to the source 126 to control actuation of the source 126.

FIG. 1 shows acoustic energy illustrated as an expanding, spherical signal, illustrated as semicircles of increasing radius centered at the source 126, representing a down-going wavefield 128, following a signal emitted by the source 126. The down-going wavefield 128 is, in effect, shown in a vertical plane cross section in FIG. 1. The outward and downward expanding down-going wavefield 128 may eventually reach the surface 106, at which point the outward and downward expanding down-going wavefield 128 may partially scatter, may partially reflect back toward the streamers 120, and may partially refract downward into the subsurface volume 104, becoming elastic signals within the subsurface volume 104.

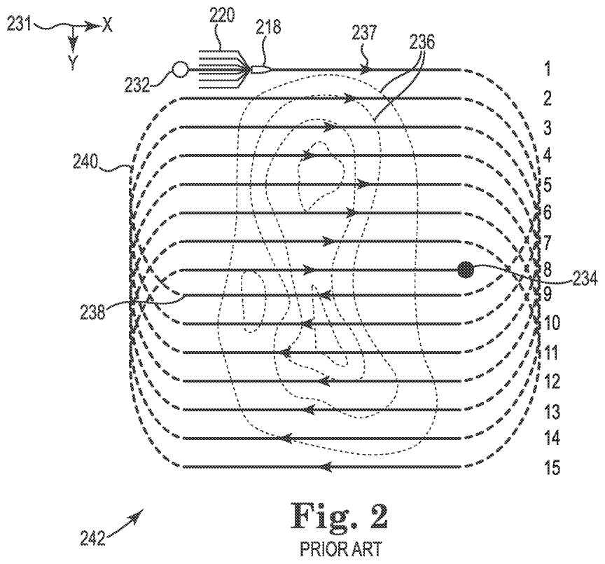

FIG. 2 is a plan or xy-plane 231 view of a marine survey route according to some previous approaches. The marine survey route includes lines 1-15 over a subterranean formation 236 located beneath a body of water. A marine survey vessel 218 may tow a set of streamers 220 and a source (not shown) along the lines 1-15. Directional arrows, such as directional arrow 237, represent the direction the survey vessel 218 sails along the lines. The survey begins at a start 232 and proceeds to an end 234. The lines 1-15 are numbered in geographic order from top to bottom rather than in the order in which they are sailed. The order in which the lines are sailed in FIG. 2 is 1, 9, 2, 10, 3, 11, 4, 12, 5, 13, 6, 14, 7, 15, 8.

When the marine survey vessel 218 reaches the end of a line, the marine survey vessel 218 may stop activating the source, stop measuring wavefields and recording data, and follow the path represented by an arc to a different line and begin activating the source and measuring wavefields and recording data. For example, at the end 238 of the line 9, the marine survey vessel 218 may stop measuring wavefields and recording data, and follow the turn 240 to the line 2, where the marine survey vessel 218 may measure wavefields and record data along the line 2. The marine survey vessel 218 may continue this pattern of activating the source, measuring wavefields, and recording data along each of the lines 1-15 until the marine survey vessel 218 reaches the end 234 of the line 8.

The lines 1-15 shown in FIG. 2 are illustrated as straight paths to be sailed by the marine survey vessel 218. In practice, however, the marine survey vessel 218 is subject to shifting currents, winds, and tides and may only be able to travel approximately parallel straight lines. In addition, the streamers 220 towed behind the marine survey vessel 218 may not be towed directly behind the marine survey vessel 218 because the streamers 220 are subject to changing conditions, such as weather and currents. As a result, the streamers 220 may deviate laterally from the track in a process called “feathering.”

As illustrated, the marine survey route typically employed in some previous approaches effectively begins by sailing along a first line 1, turning at and end of the first line 1, and sailing in an opposite direction along a line 9 through a middle of the survey area 242 before turning back to the first direction and sailing along a second line 2 that is adjacent to the first line 1. Each turn on either side of the survey area 242 is intended to have a same turning radius. Furthermore, the first geographic half of the survey area (represented by lines 1-8) is sailed in adjacent lines in a same direction (to the right as illustrated in FIG. 2), while the second geographic half of the survey area (represented by lines 9-15) is sailed in adjacent lines in the opposite direction (to the left as illustrated in FIG. 2). If the marine survey were to include an additional area to be surveyed, a marine survey route similar to that illustrated in FIG. 2 could be duplicated for the additional area, which could result in a turn after the end point 234 having approximately double the radius of the previous turns in order to start surveying in the additional area.

The marine survey route illustrated in FIGS. 3A-3B includes first and second portions. The first portion of the marine survey route is sailed before the second portion. FIG. 3A is a plan or xy-plane 331 view of an exemplary embodiment of a first portion of a marine survey route. The marine survey route includes lines 1-24 in a survey area 342 over a subterranean formation (not shown) located beneath a body of water. A marine survey vessel (not shown) can tow a set of streamers (not shown) and a source (not shown) along the lines 1-24. The survey begins at a start point 332. The lines 1-24 are numbered in geographic order from top to bottom rather than in the order in which they are sailed. The order in which the lines are sailed in the first portion of the marine survey route illustrated in FIG. 3A is 1, 8, 2, 10, 3, 12, 4, 14, 5, 16, 6, 18, 7.

When the marine survey vessel reaches the end of a line, the marine survey vessel can stop activating the source, stop measuring wavefields and recording data, and follow the path represented by an arc to a different line and begin activating the source and measuring wavefields and recording data. For example, at the end 338-2 of the line 2, the marine survey vessel can stop measuring wavefields and recording data, and follow the turn 340-2 to the line 10, where the marine survey vessel can measure wavefields and record data along the line 10. At the end 338-10 of the line 10, the marine survey vessel can stop measuring wavefields and recording data, and follow the turn 340-10 to the line 3, where the marine survey vessel can measure wavefields and record data along the line 3. The ends 338-2, 338-10 are numbered with a hyphen and extra numeral to indicate the number of the line with which they are associated. For example, the end 338-2 is associated with line 2 and the end 338-10 is associated with line 10.

During the first portion of the marine survey route, as illustrated in FIG. 3A, the marine survey vessel can sail in a first direction 345-1 (to the right as shown) along adjacent lines (lines 1-7 as shown) and sail in a second direction 345-2 (to the left as shown) along nonadjacent lines (lines 8, 10, 12, 14, 16, and 18 as shown). In at least one embodiment, and as illustrated in FIG. 3A, the nonadjacent lines can be alternating lines (adjacent lines are sailed in opposite directions). The second direction 345-2 is opposite of the first direction 345-1.

The marine survey vessel can turn with an increasingly wide radius after sailing each line in the first direction 345-1 and the second direction 345-2 for the first portion of the marine survey route. For example, the turn 340-1 from line 1 to line 8 skips 6 lines; the turn 340-2 from line 2 to line 10 skips 7 lines; the turn 340-3 from line 3 to line 12 skips 8 lines; the turn 340-4 from line 4 to line 14 skips 9 lines; the turn 340-5 from line 5 to live 16 skips 10 lines; the turn 340-6 from line 6 to line 18 skips 11 lines. The radius of each turn 340 is approximately equal to the number of lines skipped times a width of each line divided by two. As used herein, the term “radius” does not require that a marine survey vessel turns in a circular arc. In at least one embodiment, the arc is not circular either by design or because of the limitations of operating a marine survey vessel in varying conditions.

Marine survey vessels are not restricted to sailing in straight lines as described herein. The route sailed can be curved, circular, or any other suitable non-linear route. For example, in coil shooting surveys, a marine survey vessel travels in a series of overlapping, continuously linked circular, or coiled paths. The circular shooting geometry can enable acquisition of a full range of offset data across every azimuth to sample the subsurface geology in all directions.

FIG. 3B is a plan or xy-plane 331 view of an exemplary embodiment of a first and a second portion of a marine survey route. The second portion of the marine survey route includes, in chronological order (the order in which the lines are sailed), lines 19, 9, 20, 11, 21, 13, 22, 15, 23, 17, and 24, with the end indicated at 334. During the second portion of the marine survey route, as illustrated in FIG. 3B, the marine survey vessel can sail in a first direction 345-1 (to the right as shown) along nonadjacent lines (lines 9, 11, 13, 15, and 17 as shown) and sail in a second direction 345-2 (to the left as shown) along adjacent lines (lines 19-24 as shown). The lines in the first and second directions described above for the first portion of the marine survey route can be sailed before the lines in the first and second directions for the second portion of the marine survey route. Thus, the first portion and the second portion of the marine survey route each cover some geographically discontinuous portions of the survey area 342. However, collectively, the first portion and the second portion of the marine survey route cover the entire survey area 342.

The marine survey vessel can turn with an increasingly narrow radius after sailing each line in the first direction 345-1 and the second direction 345-2 for the second portion of the marine survey route. For example, the turn 340-7 from line 7 to line 19 skips 11 lines; the turn 340-9 from line 9 to line 20 skips 10 lines; the turn 340-11 from line 11 to line 21 skips 9 lines; the turn 340-13 from line 13 to line 22 skips 8 lines; the turn 340-15 from line 15 to line 23 skips 7 lines; the turn 340-17 from line 17 to line 24 skips 6 lines.

The adjacent lines (lines 1-7 as shown) sailed during the first portion of the marine survey route can be referred to as a first continuous subarea 344-1 of the survey area 342. The adjacent lines (lines 19-24 as shown) sailed during the second portion of the marine survey route can be referred to as a second continuous subarea 344-2 of the survey area 342. The alternating lines (lines 8-18 as shown) sailed during the first and second portions of the marine survey route can be referred to as a third continuous subarea 344-3 of the survey area 342. The first continuous subarea 344-1 is adjacent to the second continuous subarea 344-2. The second continuous subarea 344-2 is adjacent to the third continuous subarea 344-3. The third continuous subarea 344-3 is between the first continuous subarea 344-1 and the second continuous subarea 344-2. The three continuous subareas 344-1, 344-2, 344-3 cover the entire survey area 342.

Geophysical data can be obtained from a marine survey, such as a seismic, electromagnetic, or other type of marine survey. The marine survey can measure physical properties of the subsurface, along with anomalies in those properties, which can be used to detect or infer the presence and position of economically useful geological deposits such as hydrocarbons. Geophysical data can be acquired while sailing in the first direction 345-1 along each of the adjacent lines of the first continuous subarea 344-1 and while sailing in the second direction 345-2 along each of the adjacent lines of the second continuous subarea 344-2. Geophysical data can be acquired while sailing in the first direction 345-1 along each of a first plurality of alternating lines of the third continuous subarea 344-3 and while sailing in the second direction 345-2 along each of a second plurality of alternating lines of the third continuous subarea 344-3. Geophysical data can be acquired while sailing in the first direction 345-1 along each of the adjacent lines 1-7 of the first continuous subarea 344-1 before acquiring geophysical data while sailing in the second direction along each of the adjacent lines 19-24 of the second continuous subarea 344-2. For example, the first continuous subarea 344-1 can be completely surveyed before the second continuous subarea 344-2.

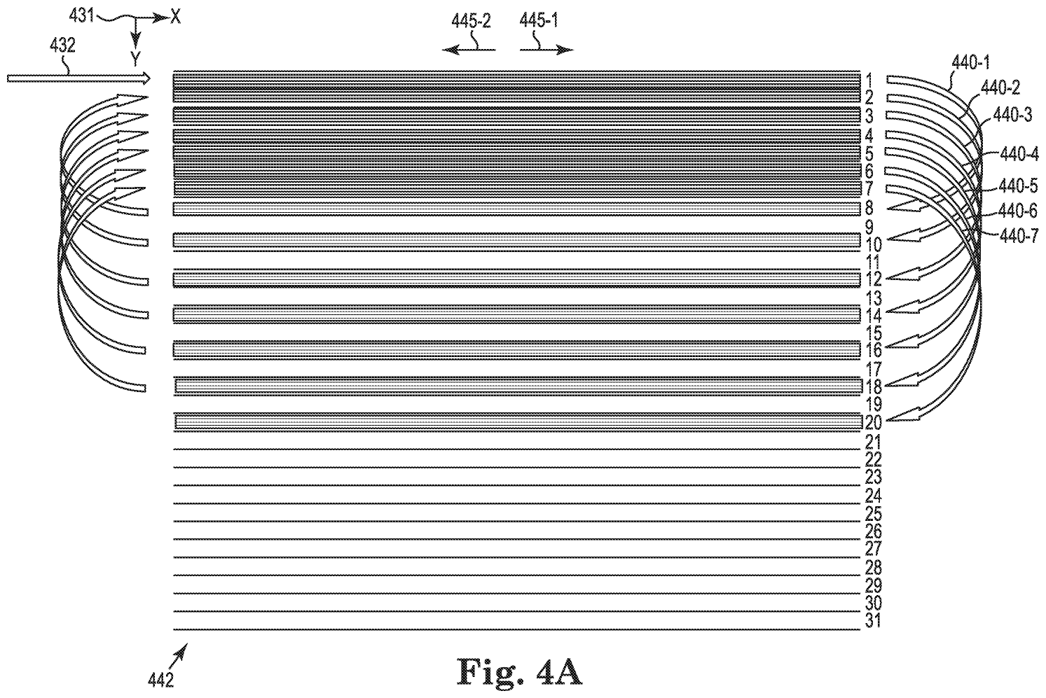

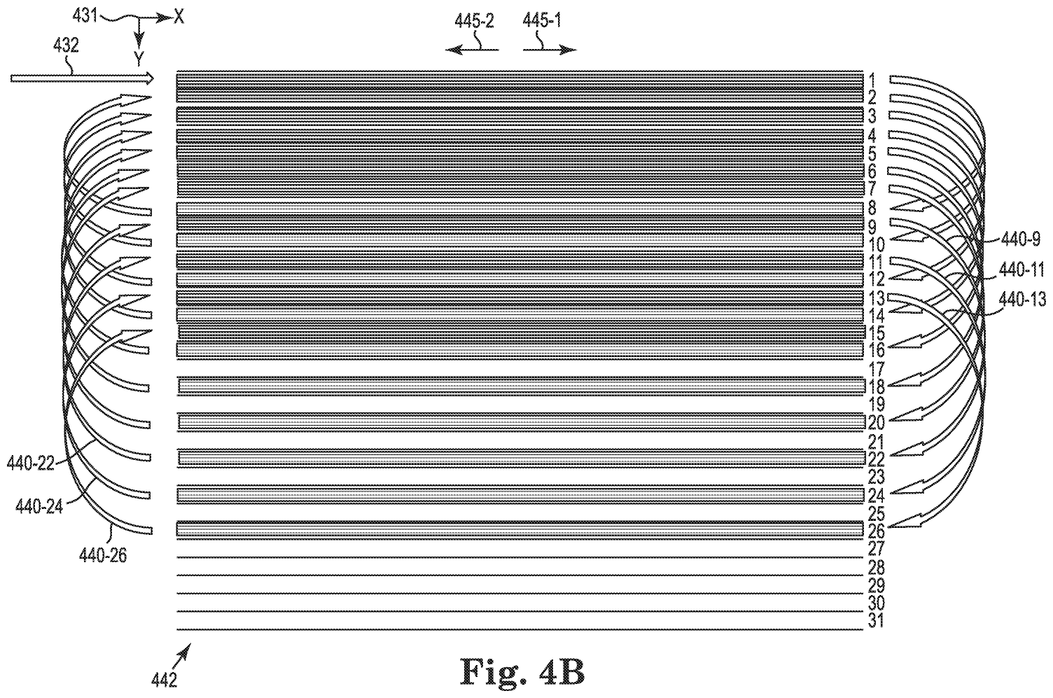

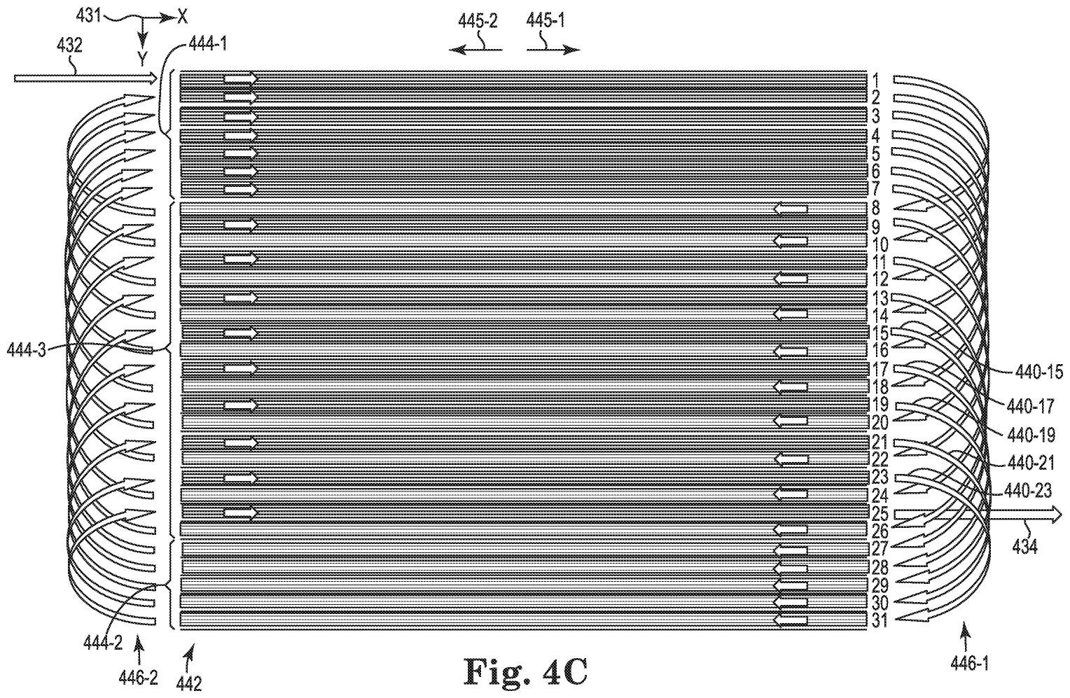

All of the lines can be sailed in a continuous swath. The continuous swath can include a series of tracks, where each track is made up of sailing along a given line in the first direction 345-1, turning on a first side 346-1 of the survey area 342, sailing along a given line in the second direction 345-2, and turning on a second side 346-2 of the survey area 342. In at least one embodiment, the last portion of the series of tracks can end with an additional three-quarter track made up of sailing along an additional line in the first direction 345-1, turning on the first side 346-1 of the survey area 342, and sailing along an additional line in the second direction 345-2. With respect to FIG. 3B, the “additional three-quarter track” is comprised of line 17, turn 340-17, and line 24 because the end 334 of the survey is on the second side 346-2 of the survey area 342 for this example. In at least one embodiment (illustrated in FIG. 4C), the last portion of the series of tracks can end with an additional one-quarter track comprising sailing along an additional line in the first direction.

The marine survey vessel can acquire the geophysical data by towing a spread of streamers. In at least one embodiment, the marine survey vessel can also tow and actuate a source. In at least one embodiment, a source can be towed by a different marine survey vessel than sails the marine survey route. In at least one embodiment, the source can be stationary.

The marine survey route illustrated in FIGS. 4A-4C includes first, second, and third portions. The third portion is sailed after the first portion and the second portion is sailed after the third portion. The “portions” are so described to keep the “first portion” and the “second portion” consistent between the embodiments described in FIGS. 3A-3B and 4A-4C. FIG. 4C includes the third portion, which is not included in the example embodiment illustrated in FIGS. 3A-3B. FIG. 4A is a plan or xy-plane 431 view of an exemplary embodiment of a first portion of marine survey route. The marine survey route includes lines 1-31 in a survey area 442 over a subterranean formation (not shown) located beneath a body of water. A marine survey vessel (not shown) can tow a set of streamers (not shown) and a source (not shown) along the lines 1-31. The survey begins at a start point 432. The lines 1-31 are numbered in geographic order from top to bottom rather than in the order in which they are sailed. The order in which the lines are sailed in the first portion of the marine survey route illustrated in FIG. 4A is 1, 8, 2, 10, 3, 12, 4, 14, 5, 16, 6, 18, 7, 20.

During the first portion of the marine survey route, as illustrated in FIG. 4A, the marine survey vessel can sail in a first direction 445-1 (to the right as shown) along adjacent lines (lines 1-7 as shown) and sail in a second direction 445-2 (to the left as shown) along nonadjacent lines (lines 8, 10, 12, 14, 16, 18, and 20 as shown). The marine survey vessel can turn with an increasingly wide radius after sailing each line in the first direction 445-1 and the second direction 445-2 for the first portion of the marine survey route. For example, the turn 440-1 from line 1 to line 8 skips 6 lines; the turn 440-2 from line 2 to line 10 skips 7 lines; the turn 440-3 from line 3 to line 12 skips 8 lines; the turn 440-4 from line 4 to line 14 skips 9 lines; the turn 440-5 from line 5 to line 16 skips 10 lines; the turn 440-6 from line 6 to line 18 skips 11 lines; the turn 440-17 from line 7 to line 20 skips 12 lines.

FIG. 4B is a plan or xy-plane 431 view of an exemplary embodiment of a first portion and a third portion of a marine survey route. The third portion of the marine survey route includes, in chronological order, lines 9, 22, 11, 24, 13, 26, and 15. During the third portion of the marine survey route, as illustrated in FIG. 4B, the marine survey vessel can sail in a first direction 445-1 (to the right as shown) along nonadjacent lines (lines 9, 11, 13, and 15 as shown) and sail in a second direction 445-2 (to the left as shown) along nonadjacent lines (lines 22, 24, and 26 as shown). The lines in the first and second directions described above for the first portion of the marine survey route can be sailed before the lines in the first and second directions for the third portion of the marine survey route. Thus, the first portion and third portion of the marine survey route each cover some geographically discontinuous portions of the survey area 442. For example, FIG. 4A illustrates that the first portion of the marine survey route covers some geographically discontinuous portions of the survey area 442 because the lines 9, 11, 13, 15, 17, and 19 are not covered while the lines 10, 12, 14, 16, 18, and 20 are covered. Similarly, FIG. 4B illustrates that the second portion of the marine survey route covers some geographically discontinuous portions of the survey area 442 because the lines 17, 19, 21, 23, and 25 are not covered while the lines 18, 20, 22, 24, and 26 are covered (or were covered by the first portion of the marine survey route). The first portion of the marine survey route and the second portion of the marine survey route also cover some geographically continuous portions of the survey area 442. For example, the first of the marine survey route covers the continuous portion of the survey area 442 including lines 1-8.

The marine survey vessel can turn with a first constant radius after sailing each line in the first direction 445-1 for the third portion of the marine survey route. For example, the turn 440-9 from line 9 to line 22 skips 12 lines; the turn 440-11 from line 13 to line 24 skips 12 lines; the turn 440-13 from line 13 to line 26 skips 12 lines. The marine survey vessel can turn with a first constant radius after sailing each line in the second direction 445-2 for the third portion of the marine survey route. For example, the turn from 440-22 from line 22 to line 11 skips 10 lines; the turn 440-24 from line 24 to line 13 skips 10 lines; the turn 440-26 from line 26 to line 15 skips 10 lines.

FIG. 4C is a plan or xy-plane 431 view of an exemplary embodiment of a first portion, a third portion, and a second portion of a marine survey route. The second portion of the marine survey route includes, in chronological order (the order in which the lines are sailed), lines 27, 17, 28, 19, 29, 21, 30, 23, 31, and 25, with the end indicated at 434. During the second portion of the marine survey route, as illustrated in FIG. 4C, the marine survey vessel can sail in a first direction 445-1 (to the right as shown) along nonadjacent lines (lines 17, 19, 21, 23, and 25 as shown) and sail in a second direction 445-2 (to the left as shown) along adjacent lines (lines 27-31 as shown). The lines in the first and second directions for the first portion of the marine survey route can be sailed before the lines in the first and second directions for the third portion of the marine survey route. The lines in the first and second directions for the third portion of the marine survey route can be sailed before the lines in the first and second directions for the second portion of the marine survey route. Thus, the first, third, and second portions of the marine survey route cover geographically discontinuous portions of the survey area 442.

In at least one embodiment, sailing in the second direction 445-2 for the second portion of the marine survey route and sailing in the second direction 445-2 for the third portion of the marine survey route includes sailing along two adjacent lines. For example with respect to FIG. 4C, lines 26 and 27 are adjacent lines that are both sailed in the second direction 445-2 although line 26 is sailed during the third portion of the marine survey route and line 27 is sailed during the second portion of the marine survey route.

The marine survey vessel can turn with an increasingly narrow radius after sailing each line in the first direction 445-1 and the second direction 445-2 for the second portion of the marine survey route. The turn 440-15 from line 15 to line 27 skips 11 lines; the turn 440-17 from line 17 to line 28 skips 10 lines; the turn 440-19 from line 19 to line 29 skips 9 lines; the turn 440-21 from line 21 to line 30 skips 8 lines; the turn 440-23 from line 23 to line 31 skips 7 lines.

The adjacent lines (lines 1-7 as shown) sailed during the first portion of the marine survey route can be referred to as a first continuous subarea 444-1 of the survey area 442. The adjacent lines (lines 27-31 as shown) sailed during the second portion of the marine survey route can be referred to as a second continuous subarea 444-2 of the survey area 442. The alternating lines (lines 8-26 as shown) sailed during the first, third, and second portions of the marine survey route can be referred to as a third continuous subarea 444-3 of the survey area 442. The first continuous subarea 444-1 is continuous with the second continuous subarea 444-2. The second continuous subarea 444-2 is continuous with the third continuous subarea 444-3. The third continuous subarea 444-3 is between the first continuous subarea 444-1 and the second continuous subarea 444-2. The three continuous subareas 444-1, 444-2, 444-3 cover the entire survey area 442.

Geophysical data can be acquired while sailing in the first direction 445-1 along each of the adjacent lines of the first continuous subarea 444-1 and while sailing in the second direction 445-2 along each of the adjacent lines of the second continuous subarea 444-2. Geophysical data can be acquired while sailing in the first direction 445-1 along each of a first plurality of alternating lines of the third continuous subarea 444-3 and while sailing in the second direction 445-2 along each of a second plurality of alternating lines of the third continuous subarea 444-3. Geophysical data can be acquired while sailing in the first direction 445-1 along each of the adjacent lines 1-7 of the first continuous subarea 444-1 before acquiring geophysical data while sailing in the second direction along each of the adjacent lines 19-24 of the second continuous subarea 444-2. For example, the first continuous subarea 444-1 can be completely surveyed before the second continuous subarea 444-2.

All of the lines can be sailed in a continuous swath. The continuous swath can include a series of tracks, where each track is made up of sailing along a given line in the first direction 445-1, turning on a first side 446-1 of the survey area 442, sailing along a given line in the second direction 445-2, and turning on a second side 446-2 of the survey area 442. In at least one embodiment, the last portion of the series of tracks can end with an additional one-quarter track comprising sailing along an additional line in the first direction 445-1. With respect to FIG. 4C, the “additional one-quarter track” is comprised of line 25 because the end 434 of the survey is on the first side 446-2 of the survey area 442 for this example.

In accordance with at least one embodiment of the present disclosure, a geophysical data product may be produced or manufactured. Geophysical data may be obtained from a marine survey and stored on a non-transitory, tangible machine-readable medium. Obtaining the geophysical data can include sailing in a first direction along adjacent lines of a first continuous subarea of a survey area, sailing in a second direction along adjacent lines of a second continuous subarea of the survey area, sailing in the first direction along alternating lines of a third continuous subarea between the first continuous subarea and the second continuous subarea, and sailing in the second direction along each of a second plurality of alternating lines of the third continuous subarea. The geophysical data product may be produced by processing the geophysical data offshore or onshore either within the United States or in another country. The geophysical data product can be recorded on a non-transitory machine-readable medium, thereby creating the geophysical data product. If the geophysical data product is produced offshore or in another country, it may be imported onshore to a facility in the United States. In some instances, once onshore in the United States, geophysical analysis may be performed on the geophysical data product. In some instances, geophysical analysis may be performed on the geophysical data product offshore.

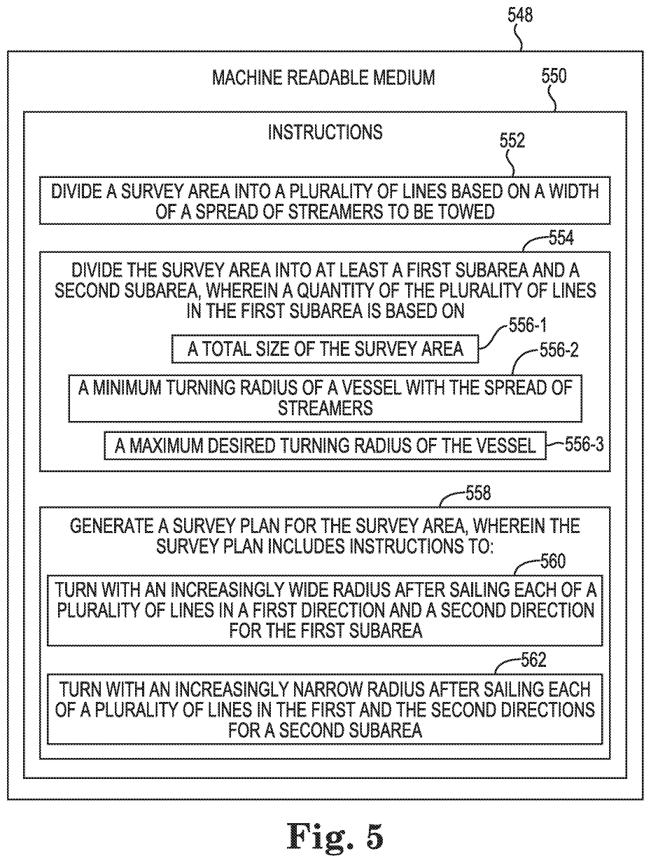

FIG. 5 illustrates an exemplary embodiment of a machine-readable medium 548 for a marine survey route. As shown in FIG. 5, the machine-readable and executable instructions 550 stored in the machine readable medium 548 can be segmented into a number of modules 552, 554, 562 that when executed by a processing resource can perform a number of functions. As used herein, a module includes a set of instructions included to perform a particular task or action. The number of modules can be sub-modules of other modules or the number of modules can comprise individual modules separate and distinct from one another. Examples are not limited to the specific modules 552, 554, 562 illustrated in FIG. 5.

In at least one embodiment, the module 552 can include instructions executable by a processing resource to divide a survey area into a plurality of lines based on a width of a spread of streamers to be towed. For example, if the width of the survey area is 31 kilometers and the width of the streamer spread is 1 kilometer, then the survey area can be divided into 31 lines (as illustrated in FIGS. 4A-4C).

The module 554 can include instructions executable by a processing resource to divide the survey area into at least a first subarea and a second subarea, for example, as described with respect to FIGS. 3A-3B. A quantity of the plurality of lines in the first subarea is based on various factors 556. A first factor 556-1 is a total size of the survey area. A second factor 556-2 is a minimum turning radius of a marine survey vessel with the spread of streamers. A third factor 556-3 is a maximum desired turning radius of the vessel. Although not specifically illustrated, the module 554 can include instructions to further divide the survey area into a third subarea, for example, as described with respect to FIGS. 4A-4C. In at least one embodiment, the instructions to divide the survey area into a third subarea can be executed in response to the plurality of lines in the survey area being of a sufficient number to cause the initially generated survey plan (with only two subareas) to include a turn that exceeds the maximum desired turning radius of the marine survey vessel.

The module 558 can include instructions executable by a processing resource to generate a survey plan for the survey area. The survey plan can include instructions, which may be referred to as submodules. A first submodule 560 can include instructions to turn with an increasingly wide radius after sailing each of a plurality of lines in a first direction and a second direction for the first subarea. A second submodule 562 can include instructions to turn with an increasingly narrow radius after sailing each of a plurality of lines in the first and the second directions for a second subarea. Although not specifically illustrated, an additional submodule can be included, with the module 558, including instructions to turn with a first constant radius after sailing each of the plurality of paths in the first direction for the third subarea and turn with a second constant radius after sailing each of a plurality of paths in the second direction for the third subarea, as described with respect to FIG. 4B.

FIG. 6 illustrates an exemplary embodiment of a system 664 for a marine survey route. The system 648 can include a controller 619 coupled to a propulsion system 672 and a navigation system 674 via one or more communication links. The controller 619 can include processing resources 668 and memory resources 670. Examples of processing resources include a processor, combinational logic, a field programmable gate array, an application specific integrated circuit, etc. The controller 619 can include a combination of hardware and machine readable instructions, which may also be referred to as program instructions. The program instructions can be stored in the memory resources 670 or embodied in the processing resources 668, which are configured to perform a number of functions described herein. For example, the program instructions can be analogous to those described with respect to FIG. 5. The controller can be configured to execute instructions to cause the propulsion system 672 and the navigation system 674 to execute the marine survey plan described herein. The program instructions, such as software, firmware, etc., can be stored in a memory resource such as a machine-readable medium, etc., as well as hard-wired program such as logic. Hard-wired program instructions can be considered as both program instructions and hardware.

The controller 619 can utilize software, hardware, firmware, and/or logic to perform a number of functions. The controller 619 can be a combination of hardware and program instructions configured to perform a number of functions and/or actions. The hardware, for example, can include a number of processing resources 668 and a number of memory resources 670, such as a machine-readable medium or other non-transitory memory resources. Although illustrated as being internal to the controller 619, the memory resources 670 can be internal and/or external to the controller 619. In at least one embodiment, the controller 619 can include internal memory resources 670 and have access to external memory resources. The program instructions, such as machine-readable instructions, can include instructions stored on the machine-readable medium to implement a particular function. The set of machine-readable instructions can be executable by one or more of the processing resources 668. The memory resources 670 can be coupled to the controller 919 in a wired and/or wireless manner. For example, the memory resources 670 can be an internal memory, a portable memory, a portable disk, and/or a memory associated with another resource, for example, enabling machine-readable instructions to be transferred and/or executed across a network such as the Internet. As used herein, a “module” can include program instructions and/or hardware, but at least includes program instructions.

The memory resources 670 can be non-transitory and can include volatile and/or non-volatile memory. Volatile memory can include memory that depends upon power to store data, such as various types of dynamic random-access memory among others. Non-volatile memory can include memory that does not depend upon power to store data. Examples of non-volatile memory can include solid state media such as flash memory, electrically erasable programmable read-only memory, phase change random access memory, magnetic memory, optical memory, and/or a solid-state drive, etc., as well as other types of non-transitory machine-readable media.

The processing resources 668 can be coupled to the memory resources 670 via a communication path. The communication path can be local or remote to the controller 619. Examples of a local communication path can include an electronic bus internal to a machine, where the memory resources are in communication with the processing resources via the electronic bus. Examples of such electronic buses can include Industry Standard Architecture, Peripheral Component Interconnect, Advanced Technology Attachment, Small Computer System Interface, Universal Serial Bus, among other types of electronic buses and variants thereof. The communication path can be such that the memory resources are remote from the processing resources, such as in a network connection between the memory resources and the processing resources. That is, the communication path can be a network connection. Examples of such a network connection can include a local area network, wide area network, personal area network, and the Internet, among others.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Various advantages of the present disclosure have been described herein, but embodiments may provide some, all, or none of such advantages, or may provide other advantages.

In the foregoing Detailed Description, some features are grouped together in a single embodiment for the purpose of streamlining the disclosure. This method of disclosure is not to be interpreted as reflecting an intention that the disclosed embodiments of the present disclosure have to use more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A method, comprising:
sailing in a first direction along each of a plurality of adjacent lines of a first continuous subarea of a survey area while acquiring geophysical data;
sailing in a second direction along each of a plurality of adjacent lines of a second continuous subarea of the survey area while acquiring geophysical data;
sailing in the first direction along each of a first plurality of alternating lines of a third continuous subarea between the first continuous subarea and the second continuous subarea while acquiring geophysical data; and
sailing in the second direction along each of a second plurality of alternating lines of the third continuous subarea while acquiring geophysical data.

2. The method of claim 1, wherein the first direction is opposite the second direction.

3. The method of claim 1, further comprising sailing a continuous swath including a series of tracks, wherein sailing a respective track comprises:
sailing along a line in the first direction;
turning on a first side of the survey area;
sailing along a line in the second direction; and
turning on a second side of the survey area.

4. The method of claim 3, wherein the method includes sailing an additional one-quarter track comprising sailing along an additional line in the first direction.

5. The method of claim 3, wherein the method includes sailing an additional three-quarter track comprising:
sailing along an additional line in the first direction;
turning on the first side of the survey area; and
sailing along an additional line in the second direction.

6. The method of claim 1, comprising sailing in the first direction along each of the plurality of adjacent lines of the first continuous subarea before sailing in the second direction along each of the plurality of adjacent lines of the second continuous subarea.

7. A method, comprising:
sailing in a first direction along adjacent lines while acquiring geophysical data for a first portion of a marine survey route;
sailing in a second direction along nonadjacent lines while acquiring geophysical data for the first portion of the marine survey route;
sailing in the first direction along nonadjacent lines while acquiring geophysical data for a second portion of the marine survey route; and
sailing in the second direction along adjacent lines while acquiring geophysical data for the second portion of the marine survey route.

8. The method of claim 7, further comprising:
sailing in the first and the second directions for the first portion of the marine survey route before sailing in the first and the second directions for the second portion of the marine survey route;
wherein the first and the second portions of the marine survey route cover geographically discontinuous portions of a survey area.

9. The method of claim 7, further comprising:
turning with an increasingly wide radius after sailing each line in the first direction and the second directions for the first portion of the marine survey route; and
turning with an increasingly narrow radius after sailing each line in the first and the second directions for the second portion of the marine survey route.

10. The method of claim 9, further comprising acquiring geophysical data while sailing; and
not acquiring data while turning.

11. The method of claim 7, further comprising:
sailing in the first direction along nonadjacent lines for a third portion of the marine survey route; and
sailing in the second direction along nonadjacent lines for the third portion of the marine survey route.

12. The method of claim 11, wherein the method includes sailing for the first portion of the marine survey route before sailing for the third portion of the marine survey route before sailing for the second portion of the marine survey route.

13. The method of claim 11, further comprising:
turning with an increasingly wide radius after sailing each line in the first direction and the second directions for the first portion of the marine survey route;
turning with a first constant radius after sailing each line in the first direction for the third portion of the marine survey route;
turning with a second constant radius after sailing each line in the second direction for the third portion of the marine survey route; and
turning with an increasingly narrow radius after sailing each line in the first and the second directions for the second portion of the marine survey route.

14. The method of claim 11, wherein sailing in the second direction for the second portion of the marine survey route and sailing in the second direction for the third portion of the marine survey route includes sailing along two adjacent lines.

15. The method of claim 7, further comprising towing streamers while sailing.

16. The method of claim 7, further comprising towing and actuating a source while sailing.

17. A non-transitory machine readable medium storing instructions executable by a processing resource to:
divide a survey area into a plurality of lines based on a width of a spread of streamers to be towed;
divide the survey area into at least a first subarea and a second subarea, wherein a quantity of the plurality of lines in the first subarea is based on:
a total size of the survey area;
a minimum turning radius of a marine survey vessel with the spread of streamers; and
a maximum desired turning radius of the marine survey vessel; and
generate a survey plan for the survey area, wherein the survey plan includes instructions to:
turn with an increasingly wide radius after sailing each of a plurality of lines in a first direction and a second direction for the first subarea; and
turn with an increasingly narrow radius after sailing each of a plurality of lines in the first and the second directions for a second subarea.

18. The medium of claim 17, further including instructions to divide the survey area into a third subarea in response to the plurality of lines having a quantity sufficient to cause the generated survey plan to include a turn that exceeds the maximum desired turning radius of the marine survey vessel.

19. The medium of claim 18, wherein the survey plan further includes instructions to:
turn with a first constant radius after sailing each of a plurality of paths in the first direction for the third subarea; and
turn with a second constant radius after sailing each of a plurality of paths in the second direction for the third subarea.

20. A method to manufacture a geophysical data product, the method comprising:
obtaining geophysical data from a marine survey, wherein the marine survey includes:
sailing in a first direction along each of a plurality of adjacent lines of a first continuous subarea of a survey area;
sailing in a second direction along each of a plurality of adjacent lines of a second continuous subarea of the survey area;
sailing in the first direction along each of a first plurality of alternating lines of a third continuous subarea between the first continuous subarea and the second continuous subarea; and
sailing in the second direction along each of a second plurality of alternating lines of the third continuous subarea;
processing the geophysical data to generate the geophysical data product; and
recording the geophysical data product on a non-transitory machine-readable medium, thereby creating the geophysical data product.

21. The method of claim 20, wherein processing the geophysical data comprises processing the geophysical data offshore or onshore.
